(19) United States
(12) Patent Application Publication
(10) Pub. No.: US 2022/0281142 A1
(43) Pub. Date: Sep. 8, 2022

(54) Laminate Tooling Unit and Process for the Manufacture of Laminate Tooling Unit with Functional Features

(71) Applicant: Mark Kenneth Neitzke, Waterford, MI (US)

(72) Inventor: Mark Kenneth Neitzke, Waterford, MI (US)

(21) Appl. No.: 17/192,141

(22) Filed: Mar. 4, 2021

(51) Int. Cl. B29C 33/44; B29C 33/38

(52) U.S. Cl. CPC B29C 33/442; B29C 33/3842

(57) ABSTRACT

The disclosure includes a laminate tool and a process for producing laminate tooling with functional features between adjacent or non-adjacent laminate segments to provide mechanical leverage to demold a part, space for moving tool segments that allow features to be molded against the line of draw (eliminate die-locked conditions), and passage way for gas to travel.

### TECHNICAL FIELD

Construction of molds, commonly referred to as tooling, is an integral part of manufacturing technology. Unlike mathematics, chemistry and physics where solutions are derived through application of proven theory, law and experimental result, tool making is a craft comprised of a multitude of engineering disciplines, where previous experience guides one toward what they determine is an optimal solution. Traditional science problems yield a singular answer, whereas within the realm of manufacturing, tooling solutions vary in accordance to the individual's experience given the design task, the value they assign to the chosen variables, and how they rank of importance to them.

In relationship to the cost structure of products, normally stated in materials, labor, burden, and overhead, tooling is an overriding cost factor. Therefore, it is understandable that much effort has been put forth to reduce tool construction cost. Weber, U.S. Pat. No. 5,031,483 describes one process for the manufacture of laminate tooling. Weber, through the use of plates, as opposed to traditional solid blocks, discloses a mold's material cost and production time can be greatly reduced.

Manuel et al., U.S. Pat. No. 6,587,742 provides for the technology to completely seal the space between laminate plates and eliminate movement of the plates that can disrupt the precisely cut forming surface of the tool cavity. This sealing technology at least partially addresses the problem of the cooling liquid leaking between laminate plates. The interfaces between the plurality of plates were natural leak paths into the cavity and the exterior of the mold.

These references do not mention the advantage of placing traditional mold components between the plates such as lifters, slides or cores.

In one embodiment the disclosure relates to a process and apparatus to manufacture a laminate tool and several interruptions in the laminate plate surface to create functional features along the laminate tooling unit. In this regard, the laminate tooling may include interruptions along the planar (flat) surfaces of laminate plates to create a functional feature along the plates to provide venting points (as opposed to venting lines between the plates) and to provide space for the mechanical leverage features to demold, eject or remove molded parts from the cavity surface of a laminate tool. Additional part features may be employed against the line of draw through tool actions commonly known as lifters, sides, or cores. These interruptions may occur between adjacent or non-adjacent plates, or be present over a multitude of laminate plates as necessary or desired per the part design or tool construction needs. These interruptions do not necessarily have to run along parallel planes between the tool laminate plates, but rather may occur at any intersecting angle among the laminate plates of the laminate tool as required or desired by the tool design and in consideration of parts features.

In one form of the disclosure, the disclosure relates to a method to create laminate tooling by creating a 3D graphic representation of a surface contour of a part that serves to correspond in creating a graphic representation of the part on the tooling surface and sectioning the tooling into a plurality of planar laminations so that each lamination has a determined thickness. A plurality of ordered segments may be produced from a sheet material corresponding to the planar laminations of the 3D graphic representation of the tooling. During formation of the planar laminates plates, a surface of one of the plates is interrupted to create at least one desired functional feature. The functional features can provide at least one venting point to act as a vacuum in the tooling unit and allow for lifters, cores and slides to facilitate increased mechanical leverage to demold or remove a part from the tooling unit. The laminate plates that also include at least one functional feature are assembled into a stack corresponding to the 3D graphic representation to yield the laminate tooling unit with increased mechanical leverage for part removal and improved venting.

### SUMMARY

In one aspect, the disclosure relates to a process and apparatus for the manufacture of a laminate tooling with several interruptions in the laminate tool cavity surface to create space for functional features along the laminate tooling unit. The interruptions may be located between adjacent, non-adjacent, parallel, non-parallel or at any intersecting angle on the inner or cavity surface of the laminate mold tool unit.

In another aspect the disclosure includes laminate tooling with interruptions along the tooling cavity surface to allow for improved mechanical leverage and venting to facilitate improved removal of molded parts from the cavity without sticking to the individual laminate plates. The interruptions may be termed functional features and it may be desirable to provide at least one venting point, instead of venting lines on the tooling surface. In addition, the functional features may include slides, lifters and cores, which facilitate increased mechanical leverage to remove molded parts from the tooling with minimal interaction with the individual lamination plates.

In another aspect, the disclosure includes a method to manufacture laminate tooling with functional features occurring between adjacent, non-adjacent, parallel, non-parallel and on any intersecting angle on the surface of the laminate tooling unit to provide at least one venting point, instead of venting lines between the planar laminations on the tooling surface, as well as provide for cores, slide and lifts, which will facilitate in increasing mechanical leverage to ease removal of the molded parts from the tooling with minimal interaction with the individual lamination plates. Briefly, this may be attained by creating a graphic representation corresponding to surface contours on the part to be produced onto the tooling surface. The surface of the tool may be cut by CNC operation or molded or by any other methods to create the negative image of the part to be formed into the surface of the tooling. The tooling is then sectioned and cut into a plurality of planar laminations corresponding to ordered segments of the tooling from a sheet material into the planar laminations thereby creating laminate plates. Each or any plate can be equipped with interruptions forming a functional feature. The interruptions, or functional features, may be cut or molded into the surface of the planar lamination(s) to create vents, spues, lifters, slides or cores. The planar laminations may be re-stacked back together in accordance with the graphic representation of the tooling to form the laminated tooling unit.

In another aspect, the disclosure relates to creating a graphic representation of a part to be produced on a tooling surface. The tool is cut or molded to have the negative image of the part to be produced. In another aspect, the tooling unit may be a computer simulation with the 3D graphic representation of the part to be produced formed in the mold surface of the tool. In either case, the tooling unit (or computer presentation) may be into a plurality of planar laminations so that each lamination has a determined thickness. By organizing each planar lamination by thickness, a plurality of ordered segments from a sheet material may be produced corresponding to said planar laminations to create the laminate plates. Once brought together, a surface of at least one of the plates is interrupted to create at least one desired functional feature. At least one functional feature can allow for at least one venting point to act as a vacuum in the tooling unit. Other functional features may facilitate placement of mechanical leverage components such as lifters, slides and cores to demold or remove a part from the tooling unit. The laminate plates are re-assembled into a stack corresponding to the tooling having increased mechanical leverage and venting.

### BRIEF DESCRIPTION OF THE DRAWINGS

FIG. 1 is a schematic representation of a system to manufacture laminate tooling according to one aspect of the disclosure;

FIG. 2 is a flowchart showing the steps for manufacturing laminate tooling according to one aspect of the disclosure;

FIG. 3 is a representational view of a laminate tool according to one aspect of the disclosure;

FIG. 4 is sectional top view of the laminate tool of FIG. 3;

FIG. 5 is a side cross sectional view of the laminate tool of FIG. 3, showing various interruptions or functional features between the laminate plates.

### DETAILED DESCRIPTION

Referring now to the discussion that follows and also to the drawings, illustrative approaches to the disclosed systems and methods are described in detail. Although the drawings represent some possible approaches, the drawings are not necessarily to scale and certain features may be exaggerated, removed, sectioned out-of-plane or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

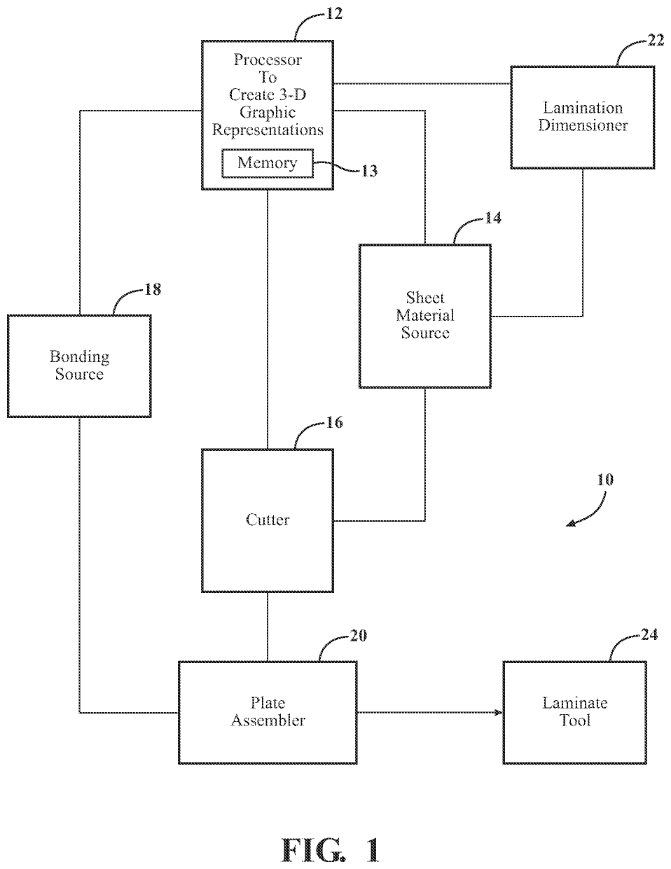

FIG. 1 discloses a schematic representation of a system to create a laminate tooling unit according to one aspect of the disclosure. Specifically, system 10 includes processor 12 having memory storing instructions capable of creating laminate tooling of any configuration as will be hereinafter described. A 3-D graphic representation of a desired laminate tool may be held in memory and constructed of individual laminate sheets. The processor 12 may communicate with the Lamination Dimensioner 22 to select the appropriate dimension for the laminate plate or the appropriate amount of laminate material necessary to construct the desired laminate plate. This information is communicated to the sheet material source 14, which may include preformed sheets of laminate or material from which the laminate sheets may be formed. The laminate sheets (or material(s)) are transferred to a cutter, which may be a laser cutter, and cut into desired shapes and dimensions. If the laminate sheets are made of a bondable material such as a plastic, the processor may also signal the optional bonding source 18 (as appropriate to the material of the planar laminations) to send bonding agent to the laminate plate assembler to bond the sheets into a laminate tool 24 as desired. A general description of a system to produce a laminate tool as described above may be seen by reference to Manuel, U.S. Pat. No. 6,587,742 incorporated herein by reference.

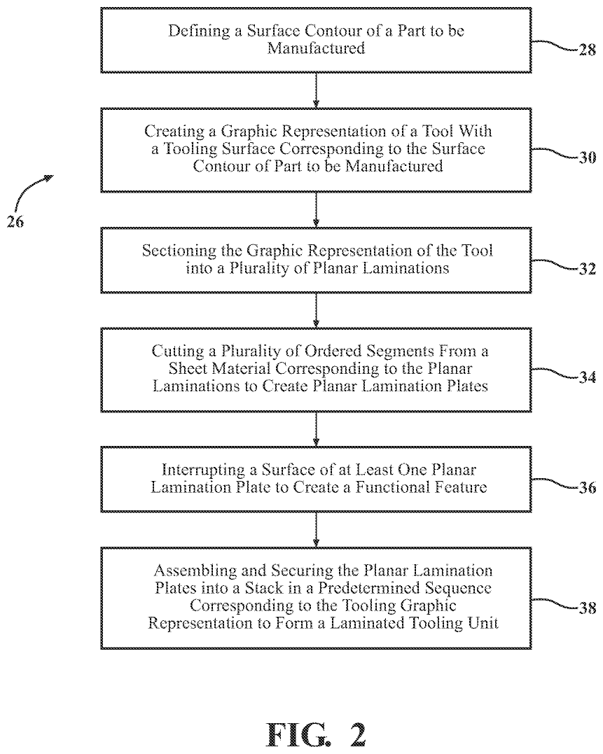

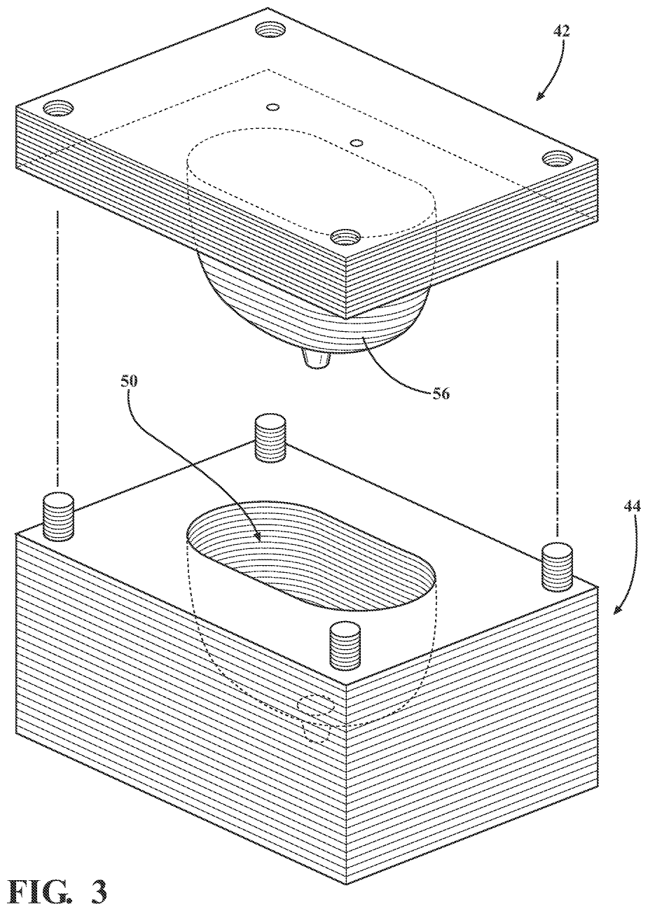

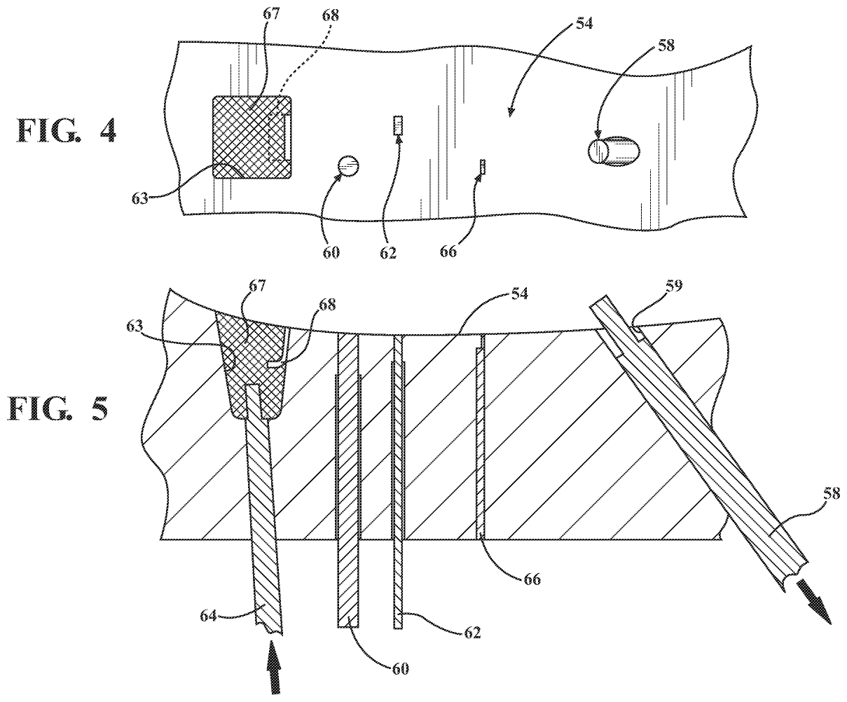

FIG. 2 is a flow chart of the method 26 to produce a laminate tooling according to one embodiment of the disclosure. Step 28 is defining a surface of a contour of a part to be molded. Step 30 is creating a 3D graphic representation of the tool with a tooling surface corresponding to the surface contour of the parts to be manufactured. The tooling may be cut or molded to correspond to the contour of the part to be produced by the laminar tooling. At step 32, the 3D graphic representation of the tooling is sectioned into a plurality of planar laminations. The tooling is then cut into a plurality of ordered segments from a sheet of material corresponding to the planar laminations to create planar lamination plates. The surface of at least one laminar plate is interrupted to create at least one functional feature. The functional features will be described in greater detail in reference to FIGS. 4 and 5. The laminar plates are assembled and secured together into a stack in a predetermined sequence corresponding to the tooling 3D graphic representation to form the laminated tooling unit as shown in FIG. 3.

Turning to FIG. 3, there is shown a representation of a laminate tool 40 suitable for molding parts. The tooling is made of a series of laminar plates 42 secured together to form a first part 44 of the tooling and laminate plates 44 to form the second part 48 of the tool. Note the first part of the laminate tooling has a mold cavity 50 which is configured to be the mirror image of the mold part contour 52 on the second such that it is a complementary male to female relationship between the mold parts.

FIGS. 4 and 5 will be described together. Specifically, FIG. 4 to a sectional top view of mold part 44 looking into the mold cavity 50. FIG. 5 is a side sectional cutaway view of the mold part 44. Shaping or forming surfaces 54 and 56, (See FIG. 3) respectively, create a cavity therebetween representative of the part to be produced. This mold cavity accepts the supply of material under pressure through a spue or gate provided in one or both of the tooling members 42 and 44. The mold members are constructed of a plurality of laminate members or sheets that are formed, cut or machined to create a shaping surface corresponding to the 3D graphic representation of a part to be molded. At various locales along the mold cavity surface 54, several interruptions may be provided. For example, the interruptions may include slides 58 or cores 59, ejectors 60 and 62, or lifters 64 to interact with a molded part surface corresponding to interruptions over several contiguous plates. In addition, the interruption may also be a vent, such as at 66. Importantly, the laminate members are, for the most part, in face to face contact with each other, being separated only by the various interruptions as described. However, it is equally understood that the interruptions or functional feature may occur along adjacent or non-adjacent laminate plates as at 67. The construction of the laminate tooling creates a mold that does not have venting between the laminate plates and greatly reduces or eliminates mold lines on a part. After the molding events have occurred, the various lifters, slides or ejectors can be used to mechanical advantage to eject the molded part from the mold. As seen in the FIGS. 4 and 5, the dog house 68 is the cavity 63. When the lifter 64 is activated, it pushes the part up and away from the dog house to free the part from the mold. It is also contemplated that the vents can be used to eject parts from the mold by the application of pressurized air through the vent and into the open mold cavity, thereby ejecting the molded part from the cavity. Instead of venting between each plate, the venting is limited to those function features that may be between adjacent or non-adjacent plates. The surface of the molded part may be understood to require minimal refinishing to create the molded part with no mold lines.

Those skilled in the art will recognize that the terms in this specification are words of description and not of limitation. Many variations and modifications are visible without departing from the scope and spirit of the invention.

I claim:

1. A method for creating a laminate tool, comprising:
a) defining a surface contour of a part;
b) creating a graphic representation of tooling with a tooling surface corresponding to the surface contour of the part;
c) sectioning the 3D graphic representation of the tooling into a plurality of planar laminations each planar lamination having a thickness;
d) cutting a plurality of ordered segments from a sheet material corresponding to said planar laminations to create planar lamination plates;
e) interrupting a surface of at least one planar lamination plate to create at least one functional feature; and
f) assembling individual planar lamination plates into a stack in a predetermined sequence corresponding to the graphic representation of the tooling and securing the individual planar lamination plates into a laminated tooling unit.

2. The process of claim 1, wherein the functional feature allows at least one venting point on the tooling surface.

3. The process of claim 1, wherein said functional feature allows for mechanical leverage to demold, eject or remove the part from the tooling unit.

4. The process of claim 1, wherein the functional features are lifters, slides, vents and cores.

5. The process of claim 1, wherein the functional features occur between adjacent planar lamination plates.

6. The process of claim 1, wherein the functional features occur between non-adjacent planar lamination plates.

7. The process of claim 1, wherein the functional features occur along parallel planes between said planar lamination plates.

8. The process of claim 1, wherein the functional features occur along non-parallel planes between said planar lamination plates.

9. The process of claim 1, wherein the functional features occur along any intersecting angle among said planar lamination plates.

10. A laminate mold tool, comprising:
a first mold part and a second mold part, said first and second mold parts formed of laminate sheets; said first mold part having a male configuration complementary to a female cavity mold configuration in said second mold part; said second mold part having a mold cavity with a surface contour in the shape of a part; each said mold part including functional features interrupting a surface of at least one laminate segment on each mold part; said functional feature including vents, cores, slides and lifters, to facilitate interaction with the mold cavity tooling surface to demold said molded part from said cavity.

11. The laminate tool of claim 10, wherein the functional features occur between adjacent planar lamination plates.

12. The laminate tool of claim 10, wherein the functional features occur between non-adjacent planar lamination plates.

13. The laminate tool of claim 10, wherein the functional features occur along parallel planes between said planar lamination plates.

14. The laminate tool of claim 10, wherein the functional features occur along non-parallel planes between said planar lamination plates.

15. The laminate tool of claim 10, wherein the functional features occur along any intersecting angle among said planar lamination plates.
